(19) United States
(12) Patent Application Publication
(10) Pub. No.: US 2010/0259105 A1
(43) Pub. Date: Oct. 14, 2010

(54) Connecting device for a photovoltaic solar module, method for the production thereof and solar installation with such a connecting device

(76) Inventors: Manfred Schaarschmidt, Lautertal (DE); Bernd Kosch, Bensheim (DE)

Correspondence Address: BARLEY SNYDER, LLC, 1000 WESTLAKES DRIVE, SUITE 275, BERWYN, PA, 19312, US

(21) Appl. No.: 12/757,686

(22) Filed: Apr. 9, 2010

(30) Foreign Application Priority Data
Apr. 9, 2009 (DE) 102009017052.9

(51) Int. Cl. H02J 1/06; H01R 43/16

(52) U.S. Cl. 307/77; 29/874

(57) ABSTRACT

A connecting device for connection to an electrical connection system of a photovoltaic solar module. The connecting device having a connector housing, at least one current-carrying component, and a plurality of diode bodies. The connector housing is positionable on the solar module, with at least one current-carrying component located in the connector housing. The plurality of diode bodies connect together with each other into a diode chain. The diode chain connects with at least one current-carrying component, and includes at least a first and second diode body, each being connected with a common diode lead.

### CROSS-REFERENCE TO RELATED APPLICATIONS

This application claims the benefit of the filing date under 35 U.S.C. § 119(a)-(d) of German Patent Application No. DE 102009017052.9 of Apr. 9, 2009.

### FIELD OF THE INVENTION

The present invention relates to a connecting device, and in particular, to a connecting device for connection to an electrical connection system of a photovoltaic solar module.

### BACKGROUND

Photovoltaic solar modules having a panel-type multilayer arrangement with solar cells arranged between two outer layers are well-known. These solar cells generate electricity through a photovoltaic effect, and generally are arranged in a corresponding space between the outer layers, being interconnected within the multilayer arrangement with an electrical connection system. The electrical connection system, which is located on the rear of the solar module opposite the light-exposed side, is connected on the outside using electrical conductors, for example in the form of connecting foils. These connecting foils are connected in one or more connecting devices, e.g. a terminal box or a junction box, to one or more electrical conductors of a connecting lead. To this end, such a connecting device includes one or more current-carrying components disposed in a connector housing, to which may be connected one or more connecting foils of the solar module or one or more electrical conductors of one or more connecting cables. In addition, one or more diodes may be contained in such a connecting device. The diodes are provided in order to prevent circulating currents between sunlight-exposed solar cells and shaded solar cells, which supply different solar currents and solar voltages. Using these diodes, for example bypass diodes, it is possible to continue operation of the module even when it is partially shaded and with corresponding reduced power.

In conventional connecting devices of this kind, also known as solar junction or connecting boxes, a plurality of such bypass diodes are connected individually with the current-carrying components. For example, in a connecting device with four current-carrying components, i.e. busbars, each current-carrying component is arranged parallel to one another, and three individual bypass diodes are provided, which in each case connect together two busbars arranged adjacent one another. To this end, the individual bypass diodes are secured in a mounting step, i.e. a mounting device, and individually mounted with two of the busbars, by connecting the diode leads exiting on both sides of a diode body to the corresponding busbar. The busbars, arranged in the connector housing, are connected to one or more electrical conductors extending out of the solar module. Provision is made, for example, for the contact path ends extending out of the solar module to be placed on or around terminal contacts of the busbars and then fixed to the busbars by suitable spring elements. There is a disadvantage with the production of these connecting devices, since the arrangement and mounting of the busbars and contacting of the bypass diodes is comparatively complex.

### SUMMARY

It is an object of the present invention, among other objects, to provide a connecting device for connection to an electrical connection system of a photovoltaic solar module, which is comparatively simple and inexpensive to produce.

The connecting device includes a connector housing, at least one current-carrying component, and a plurality of diode bodies. The connector housing is positionable on the solar module, while at least one current-carrying component is located in the connector housing. The plurality of diode bodies connect together with each other into a diode chain. The diode chain connects with at least one current-carrying component, and includes at least a first and second diode body, each being connected with a common diode lead.

### BRIEF DESCRIPTION OF THE DRAWINGS

Embodiments of the invention are described in greater detail in the following description and are shown in a simplified manner in the drawings, in which:

FIG. 1 is a schematic cross-sectional view of an embodiment of a photovoltaic solar module, which is connected to a connecting device according to the invention;

FIG. 2A is a schematic plan view of a connecting device according to the invention, having current-carrying components arranged therein and a diode chain attached to the current-carrying components;

FIG. 2B is a schematic side view of a current-carrying component with diode chain attached thereto according to the connecting device according to FIG. 2A;

FIG. 3A illustrates an embodiment of a diode chain according to the invention;

FIG. 3B illustrates another embodiment of a diode chain according to the invention;

FIG. 3C illustrates another embodiment of a diode chain according to the invention;

FIG. 3D illustrates another embodiment of a diode chain according to the invention;

FIG. 4 is a side view of a plurality of connected-together diode bodies; and

FIG. 5 is a perspective view of a store of a plurality of connected-together diode bodies.

### DETAILED DESCRIPTION OF THE EMBODIMENT(S)

Hereinafter, embodiments of the invention will be described with reference to the drawings.

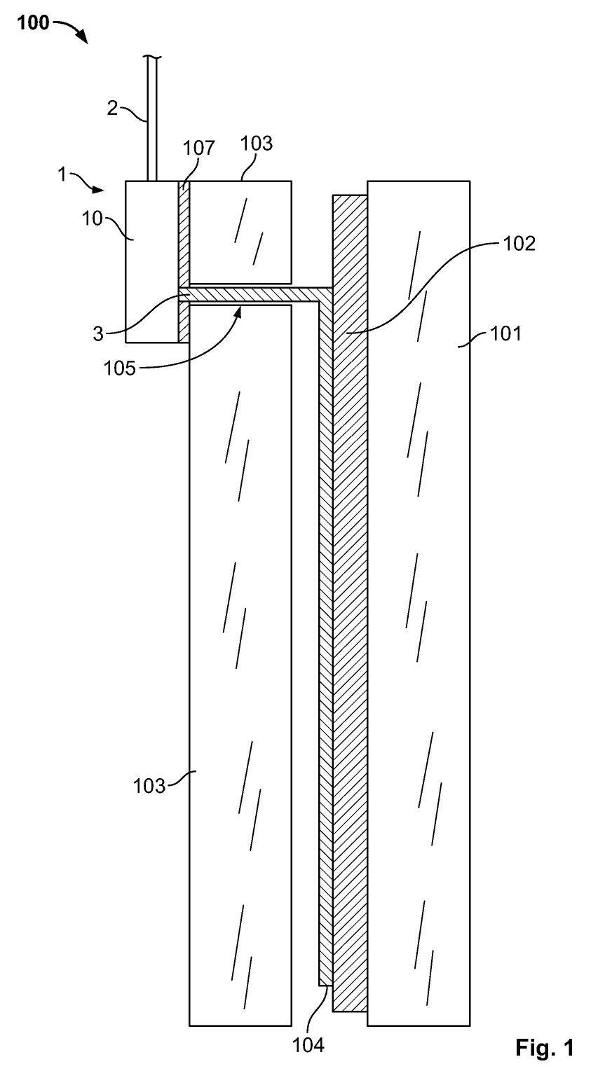

With respect to FIG. 1, a photovoltaic solar module 100 is shown provided with a connecting device 1 in the form of a junction box or connecting box. The solar module 100 includes a multilayer arrangement with a flat first layer 101 on the light-exposed side, which may take the form of a glass sheet or a film-type layer, and a flat second layer 103 on the side opposite the light-exposed side. The flat second layer 103 may likewise take the form of a glass sheet or a film-type layer. In the embodiment shown, layers 101 and 103 take the form of respective glass sheets. Between the two layers 101 and 103 there is located at least one solar cell 102 or an arrangement of a plurality of solar cells 102, which supply electricity by means of a photovoltaic effect when exposed to light. The solar cell(s) 102 is/are connected to an electrical connection system 104. This is merely indicated schematically in FIG. 1 and serves in particular to interconnect the solar cell(s) electrically to each other and to connect them to the outside world.

The electrical connection system 104 includes, for example, a copper foil, which electrically contacts the back of the solar cell(s) 102 or serves as one or more electrical conductors 3 of the solar module 100. It is also possible that the copper foil connects to at least one electrical conductor 3 of the solar module 100, which takes the form, for example, of a connecting foil or of a connecting tape and extends out of the solar module 100. Therefore, the electrical connection system 104 of the solar module 100 may be connected to an external connecting lead 2 using one or more such foil conductors 3. For example, the electrical connection system 104 may connect to a solar connecting cable.

As is also illustrated in FIG. 1, a connecting device 1 with a connector housing 10, as explained below in more detail, is attached to the back of the layer 103, which forms an outer surface of the solar module 100, for example by adhesive bonding, using for example, an adhesive 107. Furthermore, the layer 103 includes a lead-through receiving passageway 105, through which the electrical conductor 3, for instance in the form of a foil conductor may be passed to the connecting device 1.

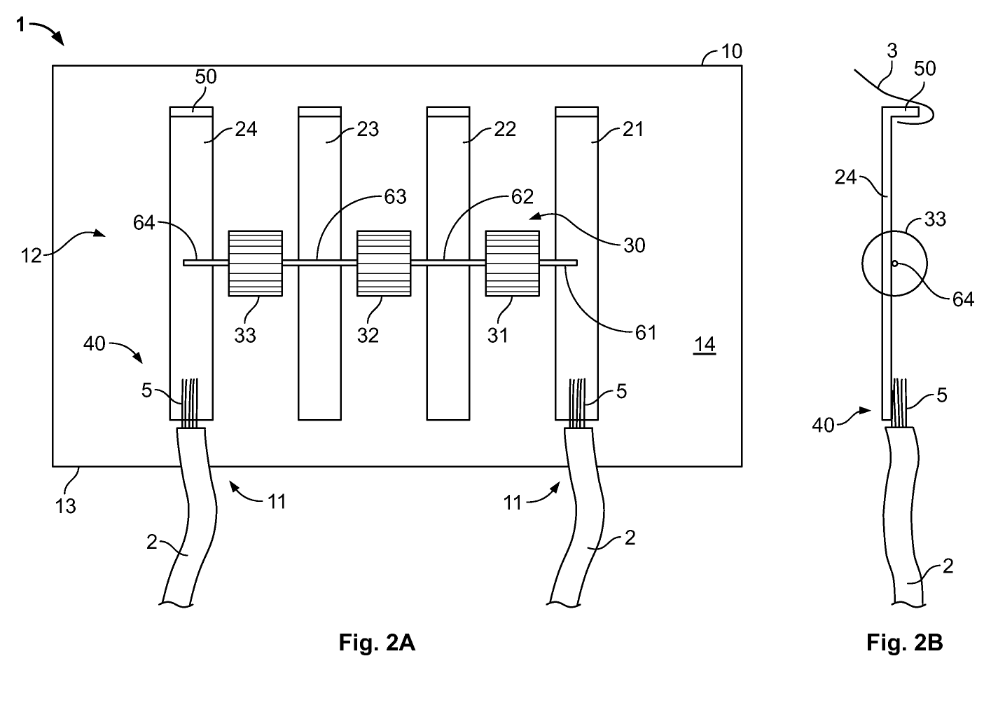

With respect to FIGS. 2A and 2B, a connector housing 10 is shown with components arranged therein, as may be used for a connecting device 1 according to FIG. 1. For example, the connector housing 10, which is of box-like construction in the embodiment shown, contains four adjacently arranged current-carrying components, which in the embodiment shown, take the form of busbars 21 to 24 having an elongate construction. The connector housing 10 includes a base 14, which may be fixed to the solar module 100 in the manner explained in greater detail with reference to FIG. 1. The base 14 may, for example, be secured to the back of a solar panel using a layer of adhesive 107 (FIG. 1) or by another fixing mechanism. A housing opening, not shown in FIG. 2, is provided in the base 14, through which electrical conductors of the connection system of the solar module 100, for example in the form of foil conductors 3 (FIG. 1), may be led into the box-shaped connector housing 10. Such foil conductors 3 may be connected by clamps to a contact zone 50, provided therefore on the busbars 21 to 24. As shown in FIG. 2B, the contact zone 50 takes the form, for example, of a contact zone 50 that is bent upwards at right angles from an end of the busbars 21 to 24. A foil conductor 3 extending out of the solar module 100 is positioned against or around the contact zone 50 and then clamped in place by a suitable spring element (for example, in the form of a Q-spring). Furthermore, conductor lead passageways 11 are provided in the side wall 13 of the connector housing 10, which are at an opposite side from the contact zones 50. In the embodiments shown, the outer two busbars 21 and 24 include a respective contact zone 40, which is connected to the electrical conductors 5 of a respective connecting lead 2. The two busbars 22 and 23 located in the middle are connected only in their contact zones 50 with a respective foil conductor 3 of the solar module 100 connection system.

The arrangement of the busbars 21 to 24 is here only to be regarded as an example and may also vary, as required. In particular, the number of busbars used may vary as required, there being, for example, only three or indeed more than four busbars. Moreover, it is in principle possible for the busbars 21 and 24 and the conductor lead passageways 11 to be arranged in the middle of the side wall 13 of the connector housing 10, while the busbars 22 and 23 may be arranged in the right- and left-hand peripheral areas of the connector housing 10.

As shown further in FIG. 2, a diode chain 30 is formed by connected together diode bodies 31 to 33. The diode chain 30 is here preassembled. In the embodiment shown, diode bodies 31 and 32 arranged adjacent one another are connected together by a common diode lead. In particular, on a first side, a first diode body 31 includes a diode lead 61, which is connected to the busbar 21, and on the opposite side it includes a diode lead 62, which is connected to a second diode body 32 arranged adjacent the first diode body 31, thus forming a common diode lead 62 for the diode bodies 31 and 32. In other words, the diode bodies 31 and 32 are interconnected by a common, single diode lead 62. On the opposite side from the diode body 31, the diode body 32 in turn includes a diode lead 63, which is then connected to another diode body 33, which is adjacent the diode body 32, thus forming a common diode lead 63 for the diode bodies 32 and 33. On the opposite side from the diode body 32, the diode body 33 includes a diode lead 64, which in the shown embodiment terminates the diode chain 30. In the embodiment shown, the diode chain 30 includes three connected-together diode bodies 31 to 33, which are applied as a whole, already connected together, to the busbars 21 to 24. In principle, the invention may be used with a diode chain, which includes at least two diode bodies.

In a manufacturing method, according to the invention, the busbars 21 to 24 are initially arranged substantially parallel to each other, for example inserted into the interior 12 of the connector housing 10, as shown in FIG. 2. Then, the diode chain 30 is positioned within the interior 12 of the connector housing 10, by a mounting operator or a mounting device. The diode chain 30 is secured as a whole piece, and then applied to the busbars 21 to 24. For connection with the busbars 21 to 24, the diode leads 61, 62, 63 and 64 are, for example, welded, crimped or soldered to the corresponding busbars 21 to 24, or even plugged thereon. It is also possible to provide a corresponding insulation displacement contact on the respective busbar 21 to 24, into which a corresponding diode lead of the diode chain 30 may be introduced from above. In principle, any type of connection is possible, as long as the connection is suitable for connecting the diode leads 61 to 64 to the corresponding busbars 21 to 24. As shown in FIG. 2A, in a connected state, the diode chain 30 is arranged substantially perpendicularly to the busbars 21 to 24, the diode bodies 31 to 33 in each case being positioned between two busbars, and further positioned adjacent to one another. As shown in FIG. 2B, the diode bodies 31 to 33 take the form, for example, of round diodes, but may in principle assume any other structural shape.

According to another type of production, the busbars 21 to 24 may be inserted into an appropriate tool and subsequently connected to the diode chain 30, before the arrangement thus formed is inserted into the interior 12 of the connector housing 10.

In the embodiment shown, the current-carrying components take the form of individually assembled busbars, which are connected together by the bypass diodes formed by the diode bodies 31 to 33. It is also feasible, however, to replace individually assembled busbars, for example, with a printed circuit board (not shown) with applied conductive tracks and/or with a corresponding punched grid with corresponding conductor tracks, onto which the diode chain 30 is suitably applied. An embodiment formed in this way may include just one current-carrying component with a plurality of conductor tracks, which are connected in each case with appropriate parts of the diode chain 30.

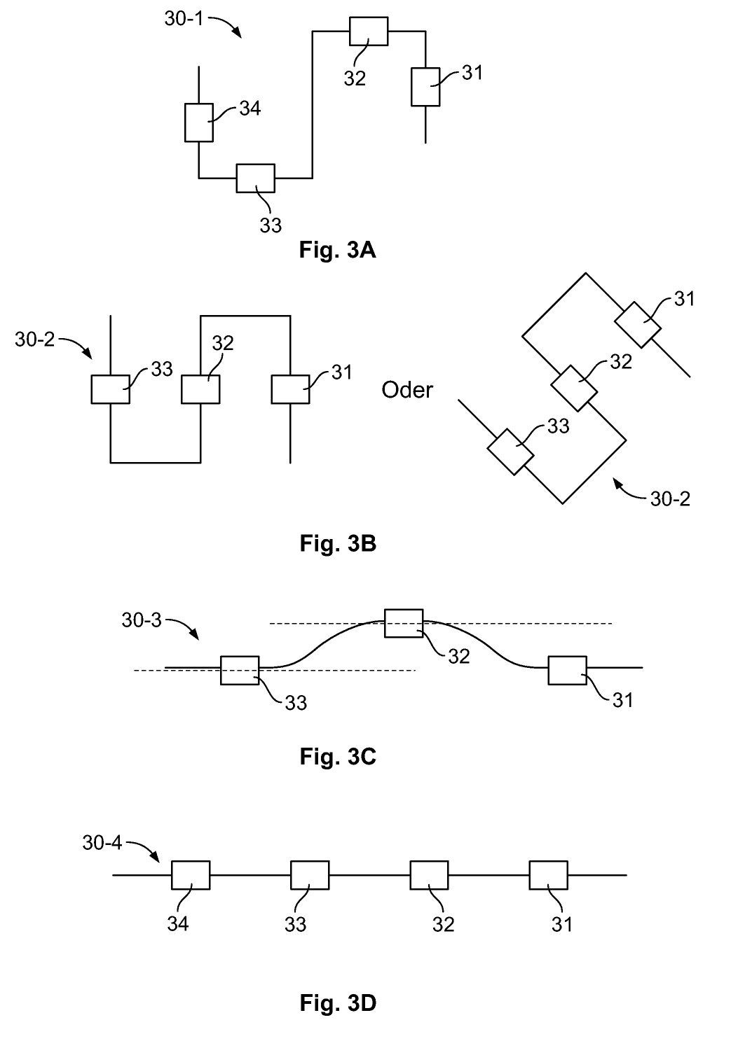

In FIG. 2 the diode bodies 31 to 33 are arranged in each case between two mutually adjacent busbars 21 to 24, the diode chain 30 itself being substantially straight and arranged at an angle to the busbars 21 to 24. However, a meandering configuration of the diode chain 30 is also possible, as shown in FIG. 3A, by way of the exemplary diode chain 30-1, in which the diode leads are bent once or repeatedly between in each case two of the diode bodies 31 to 34. In the embodiment shown, the leads are bent at right angles. For the sake of clarity, the busbars are not shown here. However, for the diode bodies 31 to 34 to be arranged, in a busbar arrangement as shown in FIG. 2, each diode bodies 31 to 34 may be positioned between two adjacent busbars. This type of construction is also applicable to the embodiments of the diode chain described below.

According to the embodiment shown in FIG. 3B, the longitudinal axes of the respective diode bodies 31 to 33 of the diode chain 30-2 are provided and positioned parallel to one another. As shown, the diode leads, between each diode body 31 to 33, are bent twice, for example respectively at right angles. Such an arrangement of bypass diodes bodies 31 to 33 may under certain circumstances contribute to an even more compact arrangement of the components.

FIG. 3C shows an embodiment of a diode chain 30-3, in which the longitudinal axes of at least two of the diode bodies 31 to 33 of the diode chain 30-3 are offset relative to one another in the longitudinal extent of the diode bodies 31 to 33. In the embodiment shown, the longitudinal axes are arranged substantially parallel to one another.

FIG. 3D shows an embodiment of a diode chain 30-4, in which the longitudinal axes of the respective diode bodies 31 to 34 of the diode chain 30-4 are aligned with one another in the longitudinal extent of the diode bodies 31 to 34.

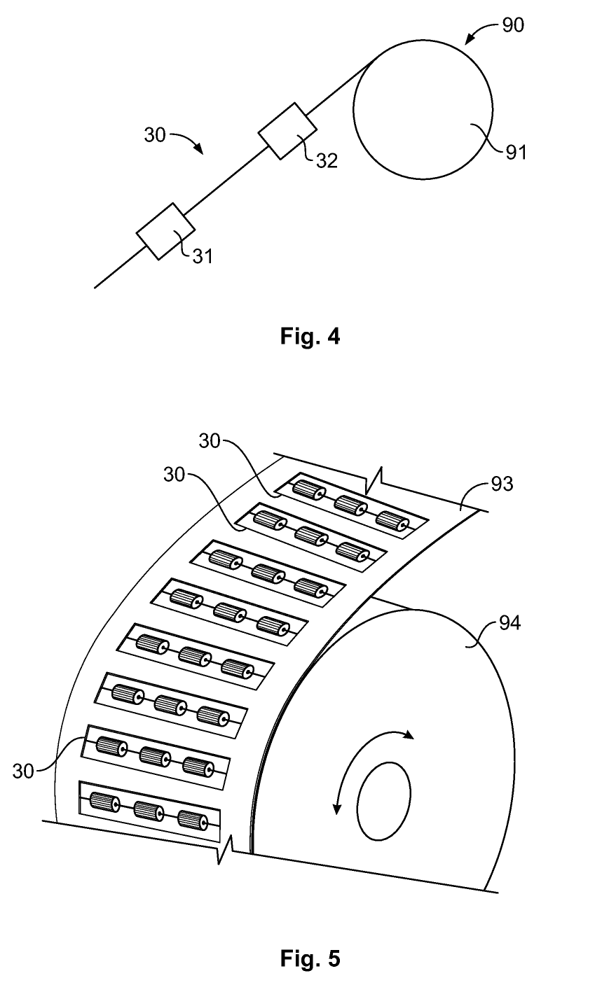

The diode chain 30 may, as shown schematically in FIG. 4, be provided by being cut to length from a store 90, for example by being cut to length from a spool 90 of a plurality of series-connected diode bodies, as a diode chain 30. The plurality of connected-together diode bodies, i.e. diode chain 30, are applied to a storage member 91, for example, in the form of a coil. The storage member 91 may here be circular in shape, as shown in FIG. 4, or indeed assume any other shape suitable for storing diodes 31, 32. Unwinding and cutting a diode chain 30 to a suitable length may be effected manually or automatically, as may the gripping and connecting of the diode chain 30 with one or more current-carrying components.

Alternatively, a diode chain 30 having a plurality of diode bodies may also be packaged in a “blister tape”, a tray 93, or a tube. A tube is substantially a tubular structure, in which the diode chain 30 is packaged. In a tray 93, the diode chains 30 are generally packaged in a single plane (instead of being wound up as in the case of tube). With tray 93 packaging the diode chains 30 may likewise be packaged using a blister pack.

With reference to FIG. 5, another embodiment is shown, in which a plurality of diode chains 30 are arranged across a support tape or tray 93. Two or three diode bodies, which are combined into respective units on the support tape or tray and may be stored on a storage member 94.

Advantages of the invention are thus in particular reduced costs for producing a connecting device 1 compared with a connection method as described in the introduction. This may result from a reduction in the number of components, in that a preassembled diode chain 30 is provided instead of individual bypass diodes, the diode chain 30 combining a plurality of bypass diodes 31 through 33 into one component, which may be produced and mounted correspondingly efficiently. This results in a reduction in the number and simplification of the components and the steps for assembly thereof

Accordingly, by providing a preassembled diode chain 30, production of a connecting device 1 of the above-mentioned type may be simplified and made less expensive to carry out. In particular it is possible, by providing a preassembled diode chain 30, i.e. a plurality of diode bodies 31 through 33, which have already been connected together into a diode chain 30 before being fitted together with the current-carrying component(s), i.e. busbars 21 through 24, to reduce parts costs for production and provision of the bypass diodes, while also facilitating a more effective mounting with the current-carrying component(s), i.e. busbars 21 through 24 in the embodiment shown. Instead of individual diodes, an already preassembled diode chain 30 of a plurality of diodes 31 through 33 is provided and mounted. By gripping and mounting the diode chain 30, a plurality of bypass diodes 31 through 33 provided in the connector housing 10 may be mounted all at once and connected to the corresponding current-carrying component(s), i.e. busbars 21 through 24 in the embodiment shown. It is no longer necessary to connect a plurality of individual bypass diodes individually to current-carrying components in a mounting step.

When producing the connecting device, provision is made for example for the diode chain to be provided by being cut to length from a store of a plurality of connected-together diode bodies, before these are connected to the corresponding current-carrying component(s). For example, the store 90 is formed by winding connected-together diode bodies, i.e. diode chains 30, onto a storage member 91. Such a store 90 of connected-together diode bodies is favourable in particular if the diode leads between the diode bodies are comparatively flexible and bendy, such that they may be applied to a coil former or the like, and the diode bodies are of a comparatively small structural shape.

While the embodiments of the present invention have been illustrated in detail, it should be apparent that modifications and adaptations to those embodiments may occur. The scope of the invention is therefore limited only by the following claims.

1. A connecting device for connection to an electrical connection system of a photovoltaic solar module, comprising:
a connector housing for positioning on the solar module;
at least one current-carrying component located in the connector housing; and
a plurality of diode bodies connected together into a diode chain, the diode chain connecting with at least one current-carrying component, the diode chain having a first diode body and a second diode body, each connected to a common diode lead.

2. The connecting device according to claim 1, wherein the diode chain connects with the at least one current-carrying component between at least two of the diode bodies.

3. The connecting device according to claim 1, wherein the common diode lead connects to the at least one current-carrying component by welding, crimping, soldering, insulation-displacement or by being plugged thereon.

4. The connecting device according to claim 1, further comprising a plurality of current-carrying components.

5. The connecting device according to claim 4, wherein each current-carrying component is a busbar.

6. The connecting device according to claim 5, further comprising a first contact zone located on a first side of the busbar for connection with at least one external electrical conductor of a connecting lead and a second contact zone located on a second side of the busbar for connection with the electrical connection system of the solar module.

7. The connecting device according to claim 5, wherein the busbars are positioned substantially parallel to one another and the diode chain is arranged at an angle to the busbars.

8. The connecting device according to claim 7, wherein the busbars are located an angle substantially perpendicular to the diode chain.

9. The connecting device according to claim 2, wherein the diode chain is in a meandering configuration.

10. The connecting device according to claim 1, wherein the longitudinal axes of the respective diode bodies of the diode chain are parallel to one another.

11. The connecting device according claim 1, wherein the longitudinal axes of at least two of the diode bodies of the diode chain are offset relative to one another in the longitudinal extent of the diode bodies.

12. The connecting device according to claim 1, wherein the longitudinal axes of the respective diode bodies of the diode chain are aligned with one another in the longitudinal extent of the diode bodies.

13. A method of manufacturing a connecting device for connection to an electrical connection system of a photovoltaic solar module, comprising the following steps:
providing at least one current-carrying component for arrangement with a connector housing, the connector housing configured for positioning with respect to the solar module;
providing a plurality of diode bodies connected into a diode chain, the diode bodies having a first diode body and a second diode body, the first and second diode bodies connected to a common diode lead; and
securing and mounting the diode chain with the current-carrying component.

14. The method according to claim 13, wherein the diode chain is formed by cutting to length from a spool of a plurality of connected together diode bodies.

15. The method according to claim 14, wherein the spool is formed by winding connected together diode bodies onto a storage member.
